(19) United States
(12) Patent Application Publication
(10) Pub. No.: US 2016/0321646 A1
(43) Pub. Date: Nov. 3, 2016

(54) METHOD FOR INITIATING A TRANSACTION BETWEEN A COMMUNICATION DEVICE AND A TRANSACTION DEVICE

(71) Applicant: BlueAccess AB, 167 51 Bromma (SE)

(72) Inventor: Niklas Magnusson, Täby (SE)

(21) Appl. No.: 15/111,827

(22) PCT Filed: Jan. 7, 2015
(86) PCT No.: PCT/US15/10402

§ 371 Date: Jul. 15, 2016

Related U.S. Application Data
(60) Provisional application No. 61/928,205, filed on Jan. 16, 2014.

(51) Int. Cl. G06Q 20/32; G06Q 20/20

(52) U.S. Cl. CPC G06Q 20/3278; G06Q 20/202; G06Q 20/3276

(57) ABSTRACT

The method is for initiating a transaction. A communication device is in communication with a plurality of POS devices via a network and senses a magnetic field of a magnet. The communication device sends a turning off command to the first device to turn off the magnetic field of the magnet and checks whether a magnetic field still exists. When no magnetic field exist, the communication device determining that the communication device is in close proximity of magnet of the first device and initiating a transaction with the first device. If a magnetic field still exists, the device sends turning-off commands to another POS device until the magnetic field is turned off to identify which POS device the communication device is next to.

### TECHNICAL FIELD

The invention relates to a method for initiating a transaction between a communication device such as a smart phone and a transaction or receiving device with which the smart phone is carrying out a transaction.

### BACKGROUND AND SUMMARY OF THE INVENTION

Payment and access to devices with a mobile telephone require an initiation of the transaction between the mobile phone and the POS (Point-Of-Sale) devices, lock or any device that is to be initiated or activated. The identification number of the POS device can be manually entered into the mobile phone by the user or by scanning a bar/QR code or by using a Near-Field-Communication (NFC) system. There are several drawbacks of the current technologies. Manual entry is both inconvenient and slow. Scanning is relatively fast but requires aiming and aligning of the mobile phone relative to a receiving or transaction device. NFC is not widely used because it is a protocol or standard that has not been implemented in the most popular mobile telephones and other similar devices.

There is a need for a fast, convenient, reliable and cost-effective method for initiating a transaction between a communication device, such as a mobile or smart telephone and a transaction/receiving device to which the transaction is initiated by the smart telephone.

The method of the present invention provides a solution to the above-outlined problems. More particularly, the method of the present invention is for initiating a transaction. The method comprises the steps of providing a communication device in communication with a first device and a second device via a network. The communication device is in close proximity to the first device or the second device and senses a magnetic field of a first or a second magnet or electro-magnetic coil. The communication device sends a turning-off command to the first device to turn off the magnetic field of the electro-magnet of the first device. The communication device determines whether a magnetic field still exists. If the magnetic field disappears, the communication device determines that the communication device is in close proximity of the electro-magnet of the first device and initiates a transaction with the first device. When a magnetic field still exists despite the sending of the first turning-off command, the communication device sends a second turning off command to the second device to turn off the magnetic field of the second electro-magnet of the second device. If the magnetic field disappears, the communication device determines that the communication device is in close proximity of the second magnet of the second device and initiates a transaction with the second device.

The method further comprises the step of using a smart phone having a sensor for sensing magnetic fields.

The method further comprises the step of the smart phone being in connection with one or a plurality of point-of-sale (POS) devices via signals in the network.

The method further comprises the step of the smart phone sensing light or vibrations from the POS devices.

The method further comprises the step of the smart phone sending a turning-off command to a microprocessor of a first POS device.

The method further comprises the step of the microprocessor of the first POS device turning off the first magnet upon receipt of the turning-off command.

The method further comprises the step of the communication device ranking POS devices based on signal strength received from the POS devices.

The method further comprises the step of providing the communication device with an application program and initiating the program to sense the POS devices.

The method further comprises the step of sending a turning-off command with different off-time parameters to all POS devices and determining the identity of the POS device based on the off-time of the magnetic field of the POS device.

### BRIEF DESCRIPTION OF DRAWINGS

FIG. 1 is a schematic view of a smart phone in communication with several POS devices;

FIG. 2 is a schematic view that shows the steps of identifying the correct POS; and

FIG. 3 is a schematic view of a smart phone and a POS in communication with a server.

### DETAILED DESCRIPTION

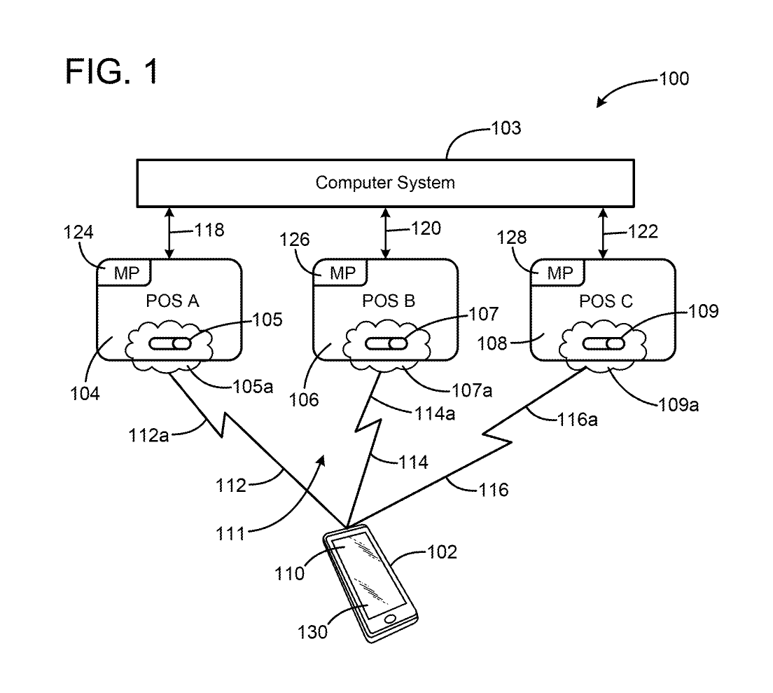

With reference to FIG. 1, the communication system 100 has a communication device 102 such as a smart phone or any other device that may be used for wireless communication with a plurality of POS (Point-Of-Sales) devices 104, 106 and 108. As described in detail below, one important feature of the present invention is that it enables to smart phone 102 to identify and determine that it is next to the correct POS device. In general, the system 100 takes advantage of the fact that the operative range of Bluetooth or Wi-Fi signals is much longer than the operative range of magnetic fields as sensed by a magnetic sensor. The magnetic fields used in the present invention are preferably constant but variable magnetic fields could also be used. The magnetism may be generated by direct current or alternating current. The POS devices 104, 106, 108 may be any suitable device that is adapted for some kind of transaction or used to activate a system such as a user of a smart phone using the smart phone when carrying out a purchase at a store. The devices 104, 106 and 108 may also be lock devices such as a lock on a door. The POS devices will here be used as an illustrative example. Preferably, the POS devices are in communication with another computer system 103, such as a computer system associated with cashier machines of a store, via communication channels 118, 120 and 122. The smart phone 102 is merely used as an illustrative example of a suitable communication device that may be used and it should be understood that any communication device that can communicate with a POS device or any other transaction/activation device may be used. The smart phone 102 senses or detects the POS devices 104, 106 and 108 via direct communication signals 112, 114 and 116 of a local wireless network 111 such as radio signals including Bluetooth, Wi-Fi or any other suitable communication network. More particularly, the smart phone 102 has an application program 130 installed therein that provides a user interface and communicates with the POS devices 104, 106 and 108 over the local network 111. Preferably, the communication system should be a short-range system, such as within 10 meters, so that the smart phone 102 only detects POS devices in the immediate area such as POS devices located in a store. The smart phone 102 preferably has a magnetic sensor 110 that senses magnetic fields such as the magnetic fields 105a, 107a and 109a of magnets or electromagnetic coils 105, 107 and 109 disposed inside the POS devices 104, 106 and 108, respectively. It is also possible for the smart phone 102 to have other types of sensors such as sensors for sensing light and vibration to be used for proximity sensing instead of the magnetic field. More particularly, the POS devices have microprocessors (MP) 124, 126 and 128, respectively, which communicates with the smart phone 102 via the local wireless network and controls the information flow between the POS devices 104, 106 and 108 and the computer system 103 connected thereto via communication channels 118, 120 and 122. The microprocessors 124, 126 and 128 also control the activation of the electromagnetic coils 105, 107 and 109, respectively, that produce the magnetic fields 105a, 107a and 109a around the POS devices and that are sensed by the magnetic sensor 110. Upon receipt of a turning-off command each microprocessor may turn off the electromagnetic coils of the particular POS device.

A user, such as a customer in a store, initiates a purchase or access-transaction by starting the application program 130 of the smart phone 102. The smart phone 102 is held next to one of the POS devices such as POS device 104 since the range sensed by sensor 110 of the magnetic field 105a from coil 105 is only a couple of centimeters. The maximum range could be longer than a couple of centimeters but should be substantially shorter than the maximum range of the signals in network 111. The magnetic field 105a is sensed by the sensor 110 and the application program 130 concludes that the smart phone 102 is close to a POS device but does not know which POS device the magnetic field belong to because the application program 130 could potentially be wirelessly connected via network 111 to more than one POS device such a to POS devices 106 and 108 also if they are located within, for example, about 10 meters which is a normal maximum range when Bluetooth is used. The smart phone 102 needs to sort out which magnetic field the sensor 110 is sensing i.e. which POS device the smart phone is next to i.e. whether it is next to POS device 104, 106 or 108. An important feature of the present invention is that the application program 130 sorts out from which POS device it is sensing the magnetic field by sequentially turning off the magnetic field of the POS devices one at the time until it can determine which magnetic field the sensor 110 is sensing i.e. which POS device is generating the magnetic field sensed by sensor 110. More particularly, the application program 130 may send a communication signal 112, such as a turning off command 112a, via network 111 to POS device 104 to turn off the power to the electromagnetic coil 105. For example, this may be done by using the microprocessor 124 that controls a transistor or switch electrically connected to the electromagnetic coil 105. The program 130 may be designed to try to turn off coil 105 first because the communication signal 112 received from the POS device 104 is the strongest of the three POS devices 104, 106 and 108 the smart phone 102 is in communication with. In other words, the program 130 may rank the POS devices based on the strength of the signals received from the POS devices via network 111 and create a ranking list of POS devices. By this, the time to find the right POS can be reduced. Other criteria for ranking the POS device may also be used. If the magnetic field 105a disappears in conjunction with the turning-off command 112, the POS device associated with the magnetic field 105a, i.e. POS device 104, in the closest proximity is found and identified and the purchase/access transaction can be started. The application program 130 can conclude that the smart phone 102 is next to POS device 104 since sensor 110 cannot sense the magnetic fields 107a and 109a generated by coils 107 and 109 associated with POS devices 106, 108, respectively, because they are too far away. If the sensor 110 still senses a magnetic field although the power to coil 105 is turned off means that smart phone 102 is in proximity to another coil such as coil 107 or 109. The program 130 then sends another turning-off command (such as turn-off command 114a or command 116a) to turn off the magnetic field generated by a coil of another POS device such as the POS device that emits the second strongest communication signal in network 111 such as POS device 106 or POS device 108, respectively. Once it has been determined which POS device the smart phone 102 is next too and it is time to initiate the transaction, communication signals, such as Bluetooth or Wi-Fi, will be sent via the network 111 between the smart phone 102 and the POS device to initiate, perform and complete the transaction such as a purchase of an item.

It is also possible to enhance the detection of the POS by adding an off-time parameter in the turn-off command. For example, 100 ms may be added in the turn-off command sent to the POS device, such as POS device 104, where the microprocessor is then turning off the magnetic field generated by the coil 105 for 100 ms. The turn-off time may be set different for each POS device to further improve the identification of each POS device. The off-time then acts like a “fingerprint” for the POS device so that the smart phone can identify which POS device it is close to.

It is thus possible to send the turn-off command simultaneously to all POS in range with different off-time parameters and the POS in proximity to the smart phone 102 being identified by the turn-off time of the detected magnetic field. For example, the three POS devices 104, 106 and 108 are in range and connected to the smart phone 102 over the local wireless network. The smart phone sends turn-off commands simultaneously to each POS device with different off-time parameters, e.g. 50 ms to POS 104, 100 ms to POS 106 and 150 ms to POS 108. The microprocessor 124 in POS device 104 turns off the magnet 105 for 50 ms, the microprocessor 126 in POS device 106 turns off the magnet 107 for 100 ms and the microprocessor 128 in POS device 108 turns off the magnet 109 for 150 ms. If the smart phone 102 is in proximity to, for example, POS 106 it will sense the magnetic field disappearing for 100 ms and by that conclude that it is close to POS 106. In other words, the length of time of the turn-off of the magnetic fields can be used to identify which POS device the smart phone 102 is close to. It is also possible to give an identity to the magnetic field by other means than the pulse time described above, for example, by a number of short pulses.

One important advantage of communicating over the local network 111 is that it eliminates the cost and hassle of connecting both the smart phone 102 and the POS device to the

Internet by, for example, using a GSM modem with the SIM-card in the smart phone 102. However, it should be pointed out that the POS devices could be connectable (by wire or wirelessly) to the Internet if necessary and communicate with the smart phone via the Internet. The POS device in the closest range could also be determined by the geographical location of all the POS devices stored at a server and the identified locations are compared to the geographical location of the smart phone 102 as detected by, for example, GPS or any other mobile network positioning system.

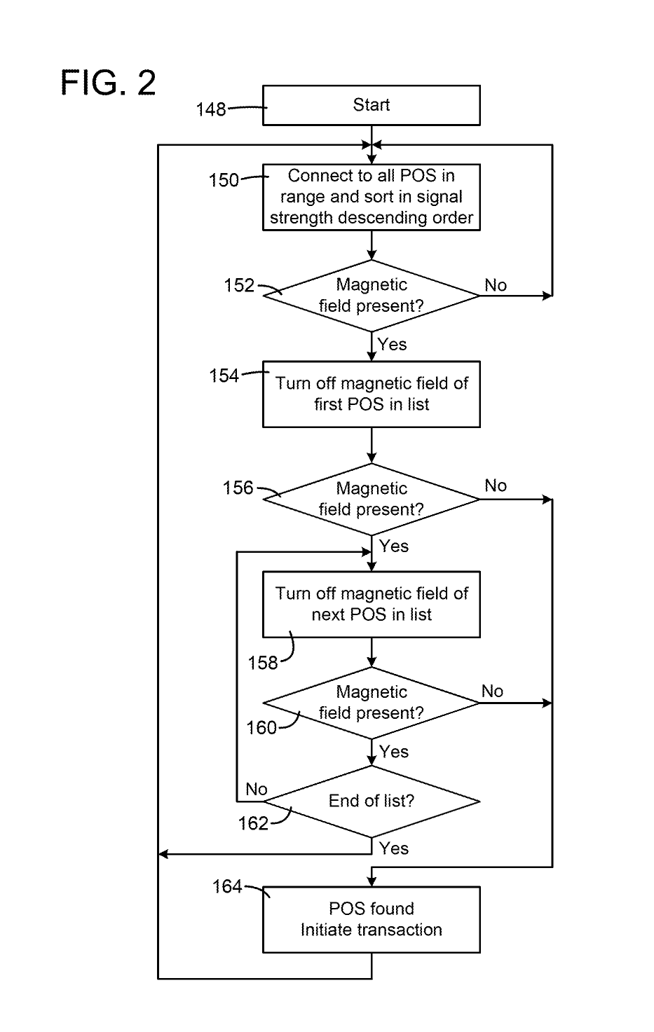

FIG. 2 shows the steps involved in order for the smart phone to find the correct POS device. In a starting step 148, the user starts the application program 130 or it may have been started automatically. In a connecting step 150, the smart phone 102 connects, for example by Bluetooth or Wi-Fi, to all the POS devices in range such as the POS devices located within range, e.g. 10 meters from the smart phone 102. Preferably, the smart phone 102 sorts the communication signals 112, 114 and 116 received from the POS devices 104, 106 and 108, respectively in descending order based on signal strength or any other suitable criteria such a geographical location of the POS devices to increase the chance of the program 130 turning off the magnetism of the correct POS device the first time and to speed up the verification process so that the transaction can start as quickly as possible. In a determining step 152, the smart phone 102 then determines if a magnetic field is present. This may be done by moving the smart phone 102 next to the POS device since the range of sensing the magnetic field is much shorter than the range of the local wireless network, e.g. 10 meters. As indicated above, the longest range of the magnetic field that can be sensed by sensor 110 could be a couple of centimeters from the POS device. If the sensor 110 detects a magnetic field, then the smart phone 102 send a command signal in a turning off step 154 to turn off the magnetic field by, for example, sending the cut-off signal 112a to cut off the power supply of the coil generating the electromagnetic field sensed by sensor 110. In a determining step 156, the smart phone 102 then determines if there is still a magnetic field present although the command has been sent to the microprocessor of the highest ranked POS device to turn off the magnetic field of the electromagnetic coil of the POS device. If there is a magnetic field still present means the smart phone turned off the magnetic field of a POS device that is further away than the POS device immediately adjacent to the smart phone 102. As indicated above, this can be done because the range of the turning off command 112a is longer than the range of sensing the magnetic field. In a turning off step 158, the smart phone 102 turns off the magnetic field of the next POS device in the list such as by sending the turn-off command 114a to POS device 106. In a determining step 160, the smart phone 102 determines if the magnetic field still exists. If the magnetic field still exists the smart phone 102 sends a turn off command to the POS device that is next in the list such as by sending turn-off command 116a to POS device 108. This continues until the magnetic field of the POS device close to the smart phone 102 is turned off. If the magnetic field still exists, the smart phone 102 determines in an end-of list step 162 whether it has reached the end of the list. If it has reached the end of the list, the smart phone 102 attempts to connect to more POS devices in range. If the magnetic field does not exist, the smart phone 102 determines, in an initiation step 164, that the POS device has been found and the transaction is initiated or activated.

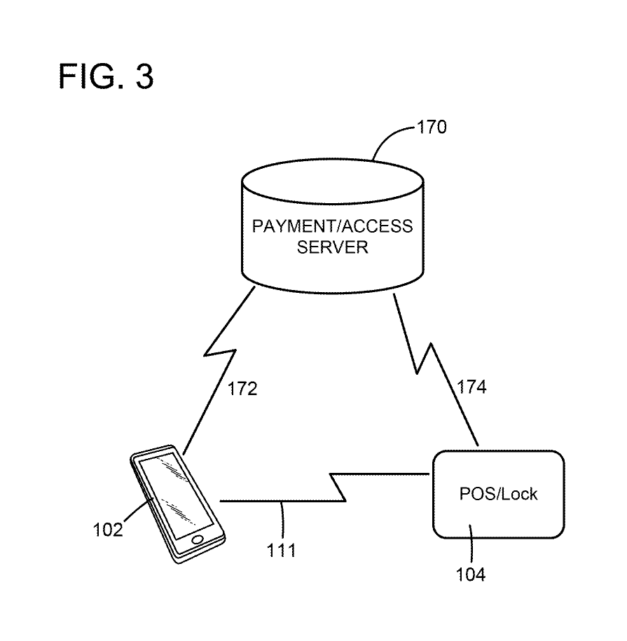

FIG. 3 is a schematic view of the smart phone 102 and the POS device 104 in communication with a server 170 that may be associated with the computer system 103 of FIG. 1. The smart phone 102 may be in communication with the POS device 104 via the local network 111. The smart phone 102 and the POS device 104 are in communication with the server 170 via signals 172 and 174, respectively, of a network such as the Internet. This means the smart phone 102 may either be connected to the Internet directly or via the network 111 and the Internet connection of the POS device 104 or vice versa. This improves the reliability of the system and is particularly useful if the mobile Internet connection is not as good as the Internet connected of the POS device 104 and the communication system 103. It is also possible that the

POS device 104 is connected to the Internet via the Internet connection of the smart phone 102 i.e. via the network 111. By letting the POS device 104 connect to the Internet via the local network 111 and then via the Internet connection of the smart phone 102 both cost savings, reliability of service and transaction speed can be achieved. It is also possible to have the system automatically select and use the Internet connection available to achieve higher redundancy.

The connections are different depending upon the specific application. For example, to keep a remotely-placed vending-machine connected to the Internet many times requires a modem and SIM-card. This involves costs for not only the investment of the hardware but also costs for installation and operation and increases the risk of service disruption. By letting the vending machine communicate with the transaction server 170 via, for example, Bluetooth/Wi-Fi networks 111, to the Internet connection of the user of the smart phone 102 the costs are reduced and the reliability is improved. Regarding retail and public transportation applications, the problem is often not related to trying to keep the store connected to the Internet because it normally has a reliable broadband connection for processing card transactions. One problem is instead to have reliable connection of the smart phone 102 to the Internet since the coverage of the Internet service provider of the smart phone 102 may be poor or temporary down. In retail and public transport applications, the speed of the transaction is often most important to ensure a high throughput of users. By connecting the smart phone 102 over Bluetooth of Wi-Fi of network 111, a reliable and predictable transaction time is achieved. In applications related to hotels, cabin rental and public transport, the problem is neither that the POS device nor the smart phone can be guaranteed to be connected to the Internet because a bus stop or a rental cabin may be in an area with poor coverage of Internet providers. In this case, time-limited access codes may be passed to the smart phone 102 when it has coverage and then be transferred to the POS device over the network 111 to provide access. When the smart phone is again in an area covered by the Internet a report about access time, status from the POS device may be sent to the server 170.

The connection in network 111, such as Bluetooth connection, and sensing of the magnetic field of the POS device or lock may be done in different orders of sequences depending on application. One possible order of sequence, as described above, is that the smart phone 102 and the POS device first connect over the Bluetooth when in range. The smart phone 102 senses the magnetic field produced by the POS device and then sends a turn-off command over Bluetooth i.e. network 111, to each POS device, one at a time, to switch of the magnetic field until the magnetic field disappears in conjunction with the turn-off command. Another possible order of sequence is that the smart phone 102 and the POS device sense the magnetic field produced by the POS device and then directly connects over Bluetooth i.e. via network 111, with the POS devices that are in range. The smart phone produced a turn-off command over Bluetooth to each POS device, one at a time, to switch off the magnetic field until the magnetic field disappears in conjunction with the turn-off command. A third possible order of sequence is that when in a battery-operated POS device is used the coil that is producing the magnetic field may normally be turned off to preserve battery. A proximity sensor in the POS device senses the presence of close objects, e.g. the smart phone 102, and the magnetic field (and Bluetooth IC) is then turned on. The continued sequence then follows the second order of sequence described above.

While the present invention has been described in accordance with preferred compositions and embodiments, it is to be understood that certain substitutions and alterations may be made thereto without departing from the spirit and scope of the following claims.

1. A method of initiating a transaction, comprising,
providing a communication device in communication with a first device and a second device via a network,
the communication device (102) being in close proximity to the first device or the second device and sensing a magnetic field of a magnet,
the communication device sending a turning off command to the first device to turn off the magnetic field of the magnet,
the communication device determining whether a magnetic field exists,
when no magnetic field exist, the communication device determining that the communication device is in close proximity of magnet of the first device and initiating a transaction with the first device,
when a magnetic field exists, the communication device sending a turning off command to the second device to turn off the magnetic field of the magnet,
when no magnetic field exists, the communication device determining that the communication device is in close proximity of the magnet of the second device and initiating a transaction with the second device.

2. The method according to claim 1 wherein the method further comprises the step of using a smart phone having a sensor for sensing magnetic fields.

3. The method according to claim 2 wherein the method further comprises the step of the smart phone sensing a plurality of point-of-sale (POS) devices via signal in the network.

4. The method according to claim 2 wherein the method further comprises the step of the smart phone sensing light or vibrations from the POS devices.

5. The method according to claim 2 wherein the method further comprises the step of the smart phone sending a turning-off command to a microprocessor of POS device.

6. The method according to claim 5 wherein the method further comprises the step of the microprocessor turning off the magnet upon receipt of the turning-off command.

7. The method according to claim 1 wherein the method further comprises the step of the communication device ranking POS devices based on signal strength received from the POS devices.

8. The method according to claim 3 wherein the method further comprises the step of providing the communication device with an application program and initiating the program to sense the POS devices.

9. The method according to claim 1 wherein the method further comprises sending a turning-off command with different off-time parameters to all POS devices and determining identity of the POS device based on the off-time of the magnetic field of the POS device.
